(19) United States
(12) Patent Application Publication
(10) Pub. No.: US 2003/0002561 A1
(43) Pub. Date: Jan. 2, 2003

(54) Detachable probe mounting arrangement for an electronic clinical thermometer

(76) Inventor: Chu-Yih Yu, San Chung City (TW)

Correspondence Address: DOUGHERTY & TROXELL, 5205 LEESBURG PIKE, SUITE 1404, FALLS CHURCH, VA, 22041, US

(21) Appl. No.: 09/895,181

(22) Filed: Jul. 2, 2001

(51) Int. Cl. G01K 1/00; G01K 7/00

(52) U.S. Cl. 374/164; 374/208

(57) ABSTRACT

An electronic thermometer includes a housing having a rear receiving chamber and an elongated front neck, a cap-like detection tip holding an induction chip at one end of the front neck of the housing for measuring the temperature of the object to which the cap-like detection tip is attached, and an electric heater mounted in one end of the front neck remote from the cap-like detection tip and controlled to pre-warm the housing when switched on the electronic thermometer to start temperature detection.

### BACKGROUND OF THE INVENTION

The present invention relates to electronic thermometers and, more specifically, to such an electronic thermometer, which uses an electric heater to pre-warm the housing, preventing the housing from absorbing heat energy received by the detection tip.

A variety of mechanical and electronic thermometers have been disclosed, and have appeared on the market. A regular electronic thermometer has a metal detection tip adapted to detect the temperature of the object to which the metal detection tip is attached. Because the housing absorbs heat energy received by the metal detection tip, it takes 2˜3 minutes to obtain the accurate temperature value (see FIG. 4). There is known an electronic thermometer with electric heater that pre-warms the housing when switched on to measure the temperature of, for example, a patient. This structure of electronic thermometer, as shown in FIG. 1, comprises a housing 1′, a cap-like detection tip 11′ fixedly fastened to the front side of the housing 1′, an induction chip 2′ and an electric heater 4′ respectively mounted in the cap-like detection tip 11′ and connected to a control circuit assembly (not shown) in the rear side of the housing 1′ by respective conductors 3′. When switching on the electronic thermometer, the electric heater 4′ is turned on to pre-warm the housing 1′, preventing the housing 1′ from absorbing heat energy received by the cap-like detection tip 11′. This design of electronic thermometer with electric heater is still not satisfactory in function. The drawbacks of this design of electronic thermometer are numerous and outlined hereinafter.

1. Because the induction chip 2′ and the electric heater 4′ are installed in the narrow inside space of the cap-like detection tip 11′, the fabrication procedure of the electronic thermometer is complicated.

2. Because the inside space of the cap-like detection tip 11′ is narrow, the capacity of the electric heater 4′ is limited, and it takes much time to warm up the housing 1′ to the desired level.

3. Because the induction chip 2′ and the electric heater 4′ are close to each other, the induction chip 2′ may be affected by the radiation heat of the electric heater 4′, resulting in a detection error.

4. Because pre-warming time is long (about 20 seconds), it takes much time (about 30 seconds, i.e. pre-warming time 20 seconds plus measuring time 10 seconds) to complete a measuring procedure.

### SUMMARY OF THE INVENTION

The present invention has been accomplished to provide an electronic thermometer, which eliminates the aforesaid drawbacks. It is the main object of the present invention to provide an electronic thermometer with electric heater, which requires less time to complete a measuring procedure. It is another object of the present invention to provide an electronic thermometer with electric heater, which achieves accurate temperature detection within a short time. According to the present invention, the housing has an elongated front neck, which separates the induction chip and the electric heater, preventing the radiation of heat of the electric heater from affecting accurate temperature detection of the induction chip. Because the electric heater is installed inside the housing remote from the cap-like detection tip, the capacity of the electric heater can be relatively increased so that the electric heater can quickly warm up the housing to the desired level during each measuring action.

### BRIEF DESCRIPTION OF THE DRAWINGS

FIG. 1 is a sectional view of a part of an electronic thermometer according to the prior art.

FIG. 2 is a perspective view of an electronic thermometer constructed according to the present invention.

FIG. 3 is a sectional view in an enlarged scale of the front part of the electronic thermometer shown in FIG. 2.

FIG. 4 is temperature-time curve obtained from an electronic thermometer without heater according to the prior art.

FIG. 5 is temperature-time curve obtained from an electronic thermometer with heater according to the prior art.

FIG. 6 is temperature-time curve obtained from the electronic thermometer according to the present invention.

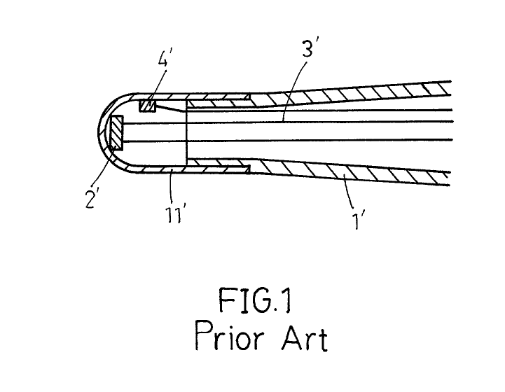

### DETAILED DESCRIPTION OF THE PREFERRED EMBODIMENT

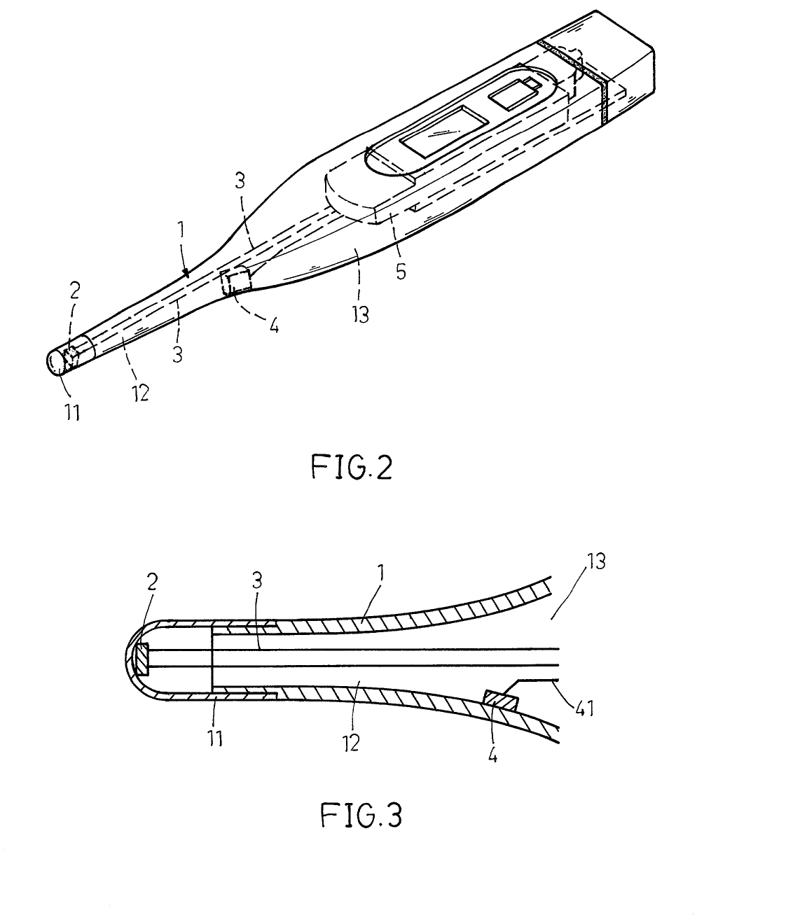

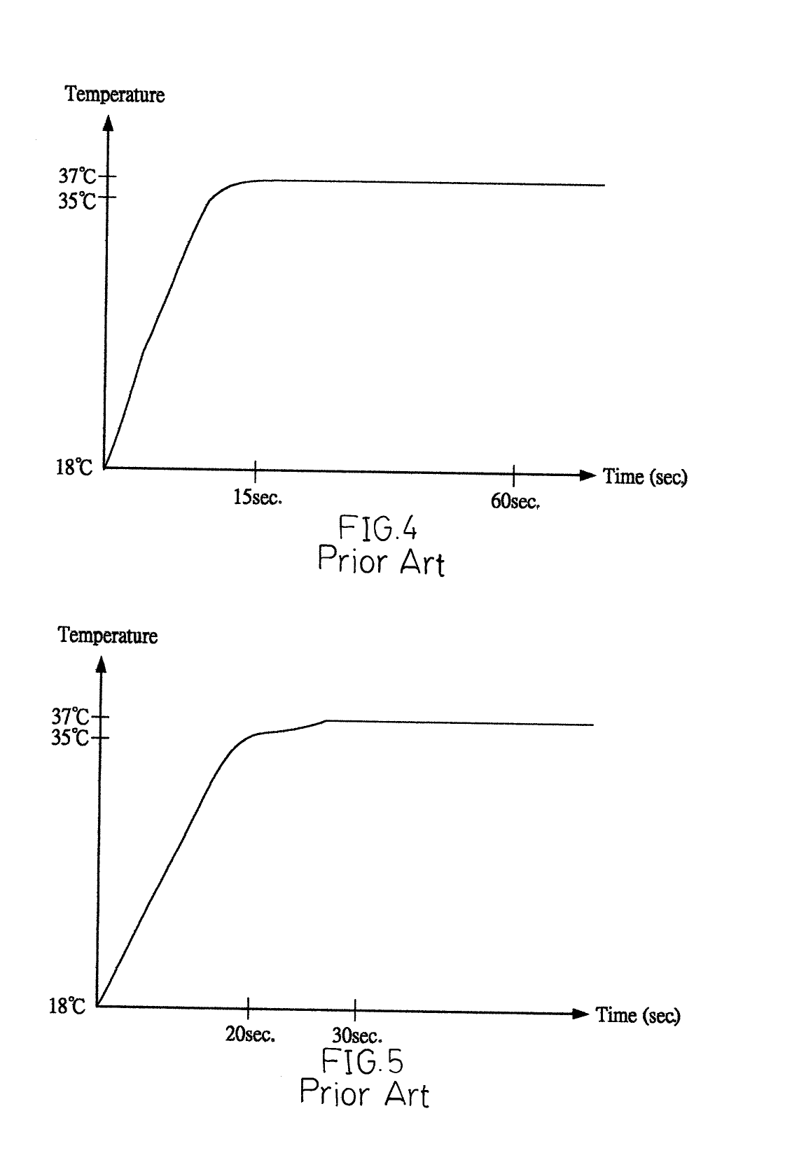

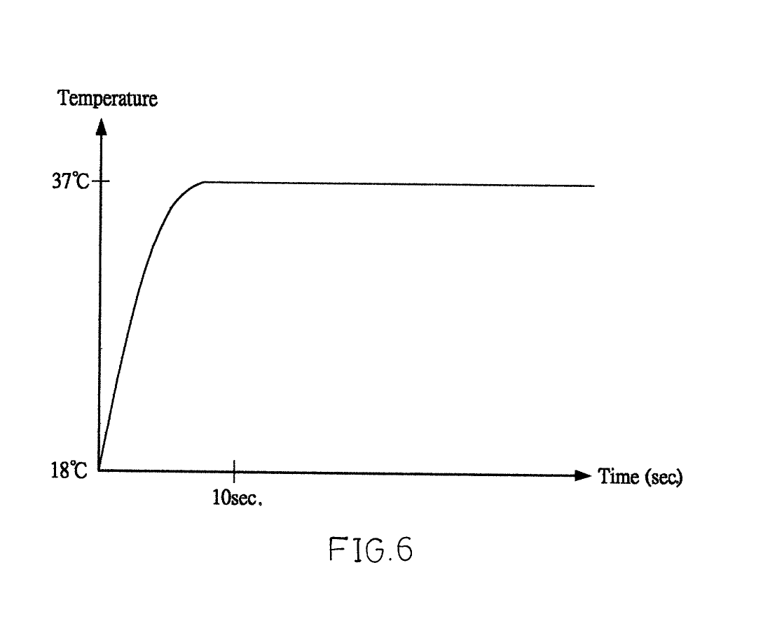

Referring to FIGS. 2 and 3, an electronic thermometer in accordance with the present invention comprises a housing 1, a cap-like detection tip 11 fixealy fastened to one end of the housing 1. The housing 1 has a rear receiving chamber 13, which receives a control circuit assembly 5. An induction chip 2 is mounted inside the cap-like detection tip 11 and adapted to detect the temperature of the object to which the cap-like detection tip 11 is attached. Conductors 3 are connected between the induction chip 2 and the control circuit assembly 5 for signal transmission from the induction chip 2 to the control circuit assembly 5. The housing 1 has an elongated front neck 12 connected between the rear receiving chamber 13 and the cap-like detection tip 11. An electric heater 4 is mounted in one end of the elongated front neck 12 remote from the cap-like detection tip 11, i.e., inside the throat between the neck 12 and the rear receiving chamber 13, and electrically connected to the control circuit assembly 5 by conductors 41.

Because the electric heater 4 and the induction chip 2 are disposed at two ends of the elongated front neck 12 of the housing 1, the induction chip 2 is free from the effect of the electric heater 4, i.e., the heating operation of the electric heater 4 does not affect accurate temperature detection of the induction chip 2.

Referring to FIG. 2, when switching on the electronic thermometer and attaching the cap-like detection tip 1 to the skin of the body of the patient, the control circuit assembly 5 immediately drives the electric heater 4 to pre-warm the housing 1 to a predetermined temperature level (for example, about 35° C.) below human body temperature, and the induction chip 2 is induced by the body temperature of the patient to output a signal to the control circuit assembly 5, causing the control circuit assembly 5 to output a digital signal indicative of the body temperature of the patient. Because the electric heater 4 is turned on to pre-warm the housing 1 when switched on the electronic thermometer, no significant temperature difference occurs between the housing 1 and the cap-like detection tip 11 during measuring. Therefore, the housing 1 does not absorb heat energy from the cap-like detection tip 11 to affect accurate detection of the induction chip 2. According to the present invention, it takes only about 10 seconds to complete one measuring action.

A prototype of electronic thermometer has been constructed with the features of FIGS. 2 and 3. The electronic thermometer functions smoothly to provide all of the features discussed earlier.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. An electronic thermometer comprising a housing having a rear receiving chamber, a cap-like detection tip fastened to a front side of said housing remote from said rear receiving chamber, a control circuit assembly mounted in said rear receiving chamber, an induction chip mounted in said cap-like detection tip and connected to aid control circuit assembly by conductors for detection the temperature of the object to which said cap-like detection tip is attached, wherein said housing comprises an elongated neck connected between said cap-like detection tip and said rear receiving chamber, and an electric heater mounted inside said housing in one end of said elongated neck remote from said cap-like detection tip and controlled by said control circuit assembly to pre-warm said housing upon operation of the electronic thermometer.
